(19) United States
(12) Patent Application Publication
(10) Pub. No.: US 2023/0177405 A1
(43) Pub. Date: Jun. 8, 2023

(54) ENSEMBLE OF NARROW AI AGENTS

(71) Applicant: Cortica Ltd., Tel Aviv (IL)

(72) Inventor: Karina Odinaev, Tel Aviv (IL)

(73) Assignee: Cortica Ltd., Tel Aviv (IL)

(21) Appl. No.: 17/755,822

(22) PCT Filed: Nov. 9, 2020
(86) PCT No.: PCT/IB2020/060542

§ 371 Date: May 9, 2022

Related U.S. Application Data
(60) Provisional application No. 62/932,066, filed on Nov. 7, 2019.

(51) Int. Cl. G06N 20/20; G06N 3/08

(52) U.S. Cl. CPC G06N 20/20; G06N 3/08

(57) ABSTRACT

A method for operating an ensemble of narrow AI agents, the method may include obtaining one or more sensed information units; determining, by a perception unit and based on the one or more sensed information units, one or more relevant narrow AI agents of the ensemble, that are relevant to a processing of the one or more sensed information units; wherein the ensemble is relevant to a first plurality of scenarios; processing the one or more sensed information units, by the one or more relevant narrow AI agents, to provide one or more narrow AI agent outputs; and processing, by an intermediate result unit, the one or more narrow AI agent outputs to provide an intermediate result; and generating a response, by a response unit, based on the intermediate result; wherein each narrow AI agent is relevant to a respective fraction of the first plurality of scenarios.

This application claims priority from US provisional patent Ser. No. 62/932,066 filing date Nov. 7, 2019—which is incorporated herein in its entirety.

### BACKGROUND

Artificial Intelligent (AI) based solutions are required to respond in an optimal manner to a vast number of scenarios.

This requirement highly complicates the AI based solutions, and also complicates the training process of the AI based solutions.

End-to-end deep learning, decomposition to models and behavior based robotics are examples of limited AI based solutions.

### End-to-End Deep Learning

For example—end-to-end deep leaning includes building a model which learns to map the raw pixels from a camera to the steering commands. No need in domain expertise, or annotated data—only requires one gigantic network

Some of the benefits of the end-to-end deep learning include (a) enabling designing a model without a deep knowledge about the problem, despite its complexity, and (b) the lack of requirement of manually tagged data.

On the other hand, end-to-end deep learning suffers from the following disadvantages: (i) the need to learn edge cases. The probability of rare events decreases exponentially with this architecture which results in an exponential growth in data is necessary to obtain required accuracy, (i) end-to-end deep learning provides a Black Box—not possible to understand and predict, and (iii) end-to-end deep learning cannot be scaled to highly autonomous devices within complex environments.

### Decomposition to Models

Decomposition to models involves breaking the task to modules: Sensors, Perception, Planning, and Control. These subsystems act together to perceive the environment around the AV, detect drivable parts of the road, plan a route to destination, predict behavior of other cars or pedestrians around it, plan trajectories, and finally execute the motion

Some of the benefits of the decomposition to models include (i) enabling a good insight into the system, and (ii) allowing optimization of each module.

On the other hand, decomposition to models suffers from the following disadvantages: (i) Decomposing to models makes it hard to compose it back into a full scene, a lot of information is lost (such as prediction, intention of agents etc.), (ii) Processing lots of unrequired information—Fitness Beats Truth, and (iii) decomposition to models cannot be scaled to highly autonomous devices within complex environments.

### Behavior Based Robotics

Behavior based robotics is an approach in robotics that focuses on robots that are able to exhibit complex-appearing behaviors despite little internal variable state to model its immediate environment, mostly gradually correcting its actions via sensory-motor links.

Some of the benefits of the Behavior based robotics include (i) ability to learn well simple environments and tasks, (ii) requires few computational resources, and (iii) allows “Mechanical Imprecision”.

On the other hand, Behavior based robotics suffers from the following disadvantages: (i) Behavior based robotics hasn't an internal world model, (ii) reactive systems aren't planning into the future and they have no idea what the outside world look like, (iii) such systems are incapable of using internal representations to deliberate or learn new behaviors, and (iv) Behavior based robotics cannot be scaled to highly autonomous devices within complex environments.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a system 10 that includes an ensemble;

FIG. 2 is an example of a method; and

FIG. 3 is an example of a method.

### DESCRIPTION OF EXAMPLE EMBODIMENTS

The specification and/or drawings may refer to an image. An image is an example of sensed information unit. Any reference to an image may be applied mutatis mutandis to a sensed information unit. The sensed information unit may be applied mutatis mutandis to a natural signal such as but not limited to signal generated by nature, signal representing human behavior, signal representing operations related to the stock market, a medical signal, and the like. The sensed information unit may be sensed by one or more sensors of at least one type—such as a visual light camera, or a sensor that may sense infrared, radar imagery, ultrasound, electro-optics, radiography, LIDAR (light detection and ranging), a non-image based sensor (accelerometers, speedometer, heat sensor, barometer) etc.

The sensed information unit may be sensed by one or more sensors of one or more types. The one or more sensors may belong to the same device or system—or may belong to different devices of systems.

There may be provided a system that is or includes an ensemble of narrow AI agents.

The ensemble may include a perception router, multiple narrow AI agents, a coordinator (or any other output processing unit) and a response module (such as an actuation for controlling an autonomous device).

The number of narrow AI agents may, for example—exceed 1000, may exceed 10,000, may exceed 100,000 and the like.

An AI narrow agent is narrow in the sense that it is not trained to respond to all possible (or all probable, or a majority of) scenarios that should be dealt by the entire ensemble. For example—each AI narrow agent may be trained to respond to a fraction (for example less than 1 percent) of these scenarios and/or may be trained to respond to only some factors or elements or parameters or variables that form a scenario.

The narrow AI agents may be of the same complexity and/or of same parameters (depth, energy consumption, technology implementation)—but at least some of the narrow AI agents may differ from each other.

The narrow AI agents may be trained in a supervised and/or non-supervised manner.

One or more narrow AI agents may be a neural network or may differ from neural networks.

The ensemble may include one or more sensors and any other entity for generating a sensed information unit and/or may receive (by an interface) one or more sensed information units from the one or more sensors. Thus—the ensemble may include an input interface and/or I/O unit for receiving the sensed information. The ensemble may include one or more sensors and receive sensed information from one or more other sensors.

The perception router may process the one or more sensed information units and determine which (one or more) narrow AI agents are relevant to the processing of the one or more sensed information units.

Different scenarios may be associated with the same number of narrow AI agents or may be associated with different numbers of narrow AI agents.

The determination of which scenarios should be associated with the narrow AI agents may be done manually, automatically, based on information units received during one or more periods of time, may be determined based on outputs of the perception router. Additionally or alternatively—the perception router can be configured to detect scenarios and/or scenario elements that are selected manually or automatically or by a combination of both manual and automatic means.

The coordinator may receive outputs of the relevant narrow AI agents and may process the outputs to provide an intermediate result that may be sent to the response unit—that may respond according to the intermediate result. The processing may include applying any function on the outputs of the relevant narrow AI agents—for example—selection of one or some of the outputs, averaging the outputs, performing a weighted sum of the outputs, and the like.

The function may be determined in advance, learnt over time, modified based on feedback regarding the responses generated by the response unit, and the like.

The scenarios processed by the ensemble may belong to various fields—security, automotive, medical devices, robotic devices, network analysis, man machine interfaces, and the like.

The following examples are provided, but they are not intended to limit the applications of the disclosed ensemble.

The ensemble (and/or the perception router, the ensemble, the coordinator and the response unit may be executed or hosted by one or more processors). A processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The system that includes the ensemble, the perception router, the ensemble, the coordinator and the response unit may be implemented by one or more processing units, by one or more integrated circuits, and the like.

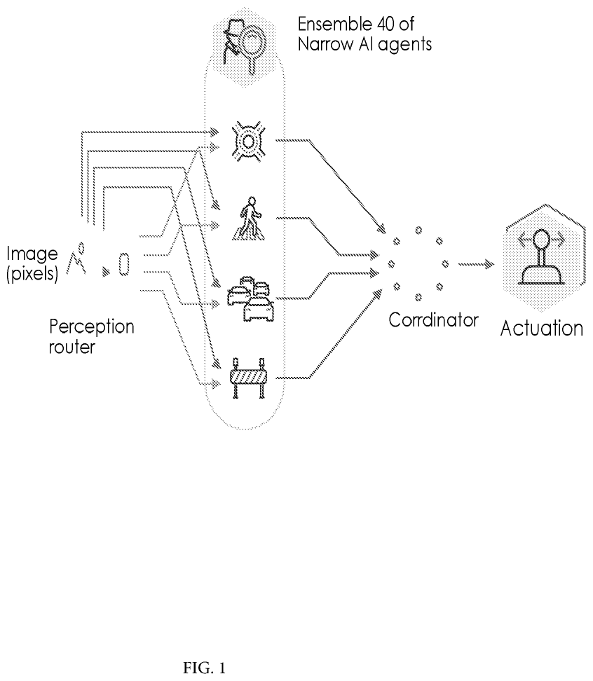

FIG. 1 illustrates an ensemble that may be used for autonomous driving (or driver aided systems) in which the response unit may control an autonomous vehicle or the response unit may suggest a propagation path to a driver.

The system 10 received one or more sensed information units such as an image, a perception router 30, an ensemble 40 of narrow AI agents, coordinator 50 and a response unit such as actuator 60.

The ensemble may be any group or arrangement or collection of narrow AI agents. FIG. 1 illustrates various narrow AI agents by showing the scenarios they are associated with—roundabout, pedestrian crossing a zebra crossing, a traffic jam, and a traffic sign or barrier.

The perception router may, for example activate (for example by sending the one or more information units or a part thereof) to the right narrow agent/s based on the sensory input from the environment and may also determine which narrow AI to activate (which is the relevant narrow AI units) based on additional factors such as a car's mission/route.

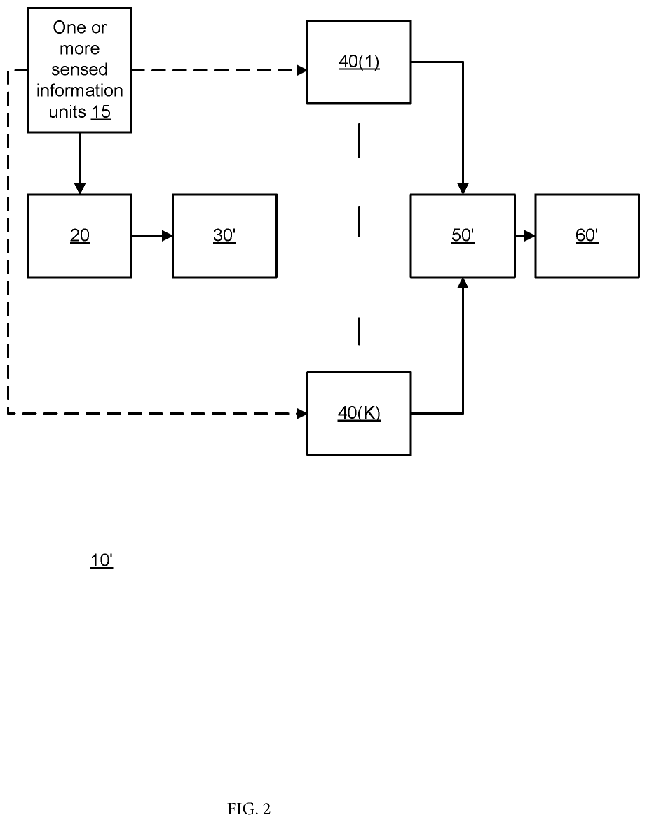

FIG. 2 illustrates the system 10′ as including an obtaining unit 20 (for receiving the one or more sensed information units 15), a perception unit 30′, narrow AI agents 40(1)-40(K), K being the number of narrow AI agents, intermediate result unit 50′ and response unit 60′.

For example—the sensed information unit may be an input image—entering a roundabout in a rainy day with obstacle inside the roundabout (tire, pothole, puddle, etc)

The different narrow AI agents may be trained to respond to different scenarios that may be (or may include) a T-junction, different road elements, a zebra crossing, roundabout, obstacles, different environmental conditions, rain, fog, night, straight highway, going up the hill, traffic jam, . . . ). Example of different obstacles and/or of different road elements is illustrated in PCT patent application WO2020/079508 titled METHOD AND SYSTEM FOR OBSTACLE DETECTION which is incorporated herein in its entirety.

The different scenarios may be different situations or may differ from situations.

A scenario may be, for example at least one of (a) a location of the vehicle, (b) one or more weather conditions, (c) one or more contextual parameters, (d) a road condition, (e) a traffic parameter.

Various examples of a road condition may include the roughness of the road, the maintenance level of the road, presence of potholes or other related road obstacles, whether the road is slippery, covered with snow or other particles.

Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

A relevant narrow AI agent may be trained to respond to one or more situations out of a much large number of situations. Examples of situations and situation based processing are illustrated in U.S. patent application Ser. No. 16/035,732 which is incorporated herein by reference.

A relevant narrow AI agent that is a roundabout agent (trained to respond to a presence of a roundabout) may output driving instructions that may include a steering angle +5 deg, slow down to 20 mps.

A relevant narrow AI agent that is an obstacle agent may output driving instructions that may include—in 5 meters set the steering angle to −25 deg.

A relevant narrow AI agent that is a rain agent (trained to respond to a presence of a rain) may output driving instructions that may include slow down by 20%.

The coordinator may be configured to receive these three driving instructions and may process them and output an intermediate result (a driving instruction in this case) of slow down to 16 mps, turn steering wheel by 5 deg to the right, and after 5 meters turn 25 deg to the left to bypass an obstacle. This is an example of a combination of outputs of narrow AI agents that are relevant to different time periods (different segments of a path that may be associated with different time periods).

This intermediate result may be used to control an autonomous vehicle and/or suggest to the driver said driving path.

The method may be applied for controlling a robotic hand.

In this example every narrow AI agent may be an expert in grabbing certain a object, shape, texture.

The perception system identifies object, shape, texture of the given object and activates the relevant narrow AI agents.

Each relevant narrow AI agent outputs the instructions (to the robotic arm) for grabbing.

The coordinator outputs the final action strategy—the instructions for controlling a grabbing of an object.

The grabbing operation may be replaced by any other mechanical operation.

The ensemble may be used for various purposes—for example navigating one or more drones.

The ensemble may provide an output that is converted to a human perceivable output by a man machine interface. The MMI is required to provide a response that may fit a sensed emotion of a person.

The perception router may analyze one or more sensed information units from one or more sensors to understand the current emotional state of a person.

For example—the sensed information may include (i) content that the person is saying, (ii) person's emotional state (embarrassed, upset, uncertain, etc).

The perception router may analyze the sensed information to understand the emotional state (for example—80% embarrassed, 10% upset, 10% uncertain) and activate the relevant narrow AI agents. Each narrow AI agent may generate its output and the coordinator integrates (or otherwise process) the outputs of all relevant narrow AI agents to determine the content of the response (words, tone, and the like) that is sent to the response unit that outputs the required audiovisual output.

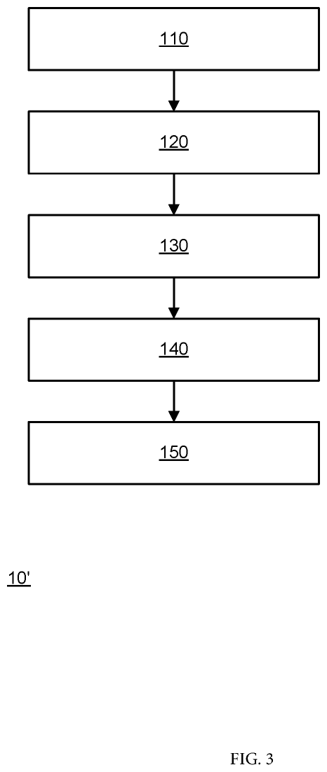

FIG. 3 illustrates method 100.

Method 100 may start by step 110 of obtaining one or more sensed information units. The obtaining may include receiving an information unit, sensing an information unit, and the like. An information unit may include any amount of sensed information, may include any format of information, and the like.

Step 110 may be executed by an obtaining unit such as an input/output unit, a communication unit, a retrieval unit, a memory unit, by an image processor, a frame grabber, one or more sensors, and the like.

Step 110 may be followed by step 120 of determining, by a perception unit and based on the one or more sensed information units, one or more relevant narrow AI agents of the ensemble, that may be relevant to a processing of the one or more sensed information units.

The perception unit may be a perception router or may differ from a perception router.

Step 120 may include determining one or more obtained scenarios that may be related to the one or more sensed information units, and determining a relevancy of the narrow AI agents based on a relationship between the one or more obtained scenarios and an association between the first plurality of scenarios and the narrow AI agents.

Step 120 may include determining that a narrow AI agent may be relevant when the narrow AI agent may be associated to any of the one or more obtained scenarios.

The association between the first plurality of scenarios and the narrow AI agents may be manually determined.

The association between the first plurality of scenarios and the narrow AI agents may be determined based on previous determining made by the perception router.

Step 120 may include determining one or more obtained scenario parts that may be related to the one or more sensed information units, and determining a relevancy of the narrow AI agents based on a relationship between the one or more obtained scenario parts and an association between the first plurality of scenarios and the narrow AI agents.

The at least some of the obtained scenario parts may be associated with one or more objects that were sensed in the one or more sensed information units.

Step 120 may be followed by feeding the one or more relevant narrow AI agents with the one or more sensed information units. This may include feeding the one or more sensed information units to each one of the one or more relevant narrow AI agents. Alternatively—this may include determining which part of the one or more sensed information units to send to each relevant narrow AI agent.

The ensemble may be relevant to a first plurality of scenarios in the sense that it is configured to respond to any scenarios of the first plurality of scenarios. Each narrow AI agent is narrow in the senses that it may be relevant to a respective fraction of the first plurality of scenarios.

The number of narrow AI agents relevant to one of the first plurality of scenarios may differ from a number of narrow AI agents relevant to another of the first plurality of scenarios.

The number of narrow AI agents may exceed 100, 1000, 10000, 100000 and even more.

A narrow AI agent may be trained to respond to a respective fraction of the first plurality of scenarios.

The at least some of the narrow AI agents may include at least a portion of a neural network.

Step 120 of the ensemble may be based on the one or more sensed information units and based on at least one additional parameter.

The at least one additional parameter may be a purpose assigned to the method.

Step 120 may be followed by step 130 of processing the one or more sensed information units, by the one or more relevant narrow AI agents, to provide one or more narrow AI agent outputs.

The processing may include applying AI processing. A narrow AI agent may be trained to apply AI processing in any manner. For example—once trained—the Narrow AI agent may executed step 130.

The narrow AI agent output may be a command.

The narrow AI agent output may be a command for autonomously controlling a vehicle.

The narrow AI agent output may be an Advanced driver-assistance systems (ADAS) command.

The narrow AI agent output may be a suggested response of the response unit.

Step 130 may be followed by step 140 of processing, by an intermediate result unit, the one or more narrow AI agent outputs to provide an intermediate result.

The intermediate result unit may be a coordinator or may differ from a coordinator.

The intermediate result unit may be configured to select at least one selected narrow AI agent output of the one or more narrow AI agent outputs.

The intermediate result unit may be configured to average the one or more narrow AI agent outputs.

Each narrow AI agent output of the one or more narrow AI agent outputs may be associated with a time period.

The different narrow AI agent outputs of the one or more narrow AI agent outputs may be associated with different time periods, wherein the intermediate result unit may be configured to generate an intermediate result that may be responsive, at each of the different time periods, to a narrow AI agent output related to the time period.

The intermediate result may include instructions for driving a vehicle.

The intermediate result may include instructions for operating a robot.

The processing by the intermediate result unit may include combining multiple narrow AI agent outputs by applying risk reduction optimization.

Step 140 may be followed by step 150 of generating a response, by a response unit, based on the intermediate result. The response may include (a) operating a device, unit or system, (b) controlling a device, unit or system, (c) storing a command, (d) executing a command, (e) transmitting a command, (f) storing a request, (g) executing a request, and (h) transmitting a request.

It should be noted that the method 100 may end at step 140. Step 150 may be executed by an entity that differs (for example by location) from any of the entities that execute any step of steps 110, 120, 130 and 140.

There may be provided a method for operating an ensemble of narrow AI agents, the method may include obtaining one or more sensed information units; determining, by a perception unit and based on the one or more sensed information units, one or more relevant narrow AI agents of the ensemble, that are relevant to a processing of the one or more sensed information units; wherein the ensemble is relevant to a first plurality of scenarios; processing the one or more sensed information units, by the one or more relevant narrow AI agents, to provide one or more narrow AI agent outputs; and processing, by an intermediate result unit, the one or more narrow AI agent outputs to provide an intermediate result; wherein the intermediate result is indicative of a response to the one or more sensed information units.

There may be provided a non-transitory computer readable medium that stores instructions for operating an ensemble of narrow AI agents, the operating may include: obtaining one or more sensed information units; determining, by a perception unit and based on the one or more sensed information units, one or more relevant narrow AI agents of the ensemble, that are relevant to a processing of the one or more sensed information units; wherein the ensemble is relevant to a first plurality of scenarios; processing the one or more sensed information units, by the one or more relevant narrow AI agents, to provide one or more narrow AI agent outputs; processing, by an intermediate result unit, the one or more narrow AI agent outputs to provide an intermediate result; and generating a response, by a response unit, based on the intermediate result wherein each narrow AI agent is relevant to a respective fraction of the first plurality of scenarios.

There may be provided a non-transitory computer readable medium that stores instructions for operating an ensemble of narrow AI agents, the operating may include: obtaining one or more sensed information units; determining, by a perception unit and based on the one or more sensed information units, one or more relevant narrow AI agents of the ensemble, that are relevant to a processing of the one or more sensed information units; wherein the ensemble is relevant to a first plurality of scenarios; processing the one or more sensed information units, by the one or more relevant narrow AI agents, to provide one or more narrow AI agent outputs; and processing, by an intermediate result unit, the one or more narrow AI agent outputs to provide an intermediate result; wherein the intermediate result is indicative of a response to the one or more sensed information units.

There may be provided a computerized system that may include an obtaining unit configured to obtain one or more sensed information units; an ensemble of narrow AI agents; a perception unit that is configured to determine based on the one or more sensed information units, one or more relevant narrow AI agents of the ensemble, that are relevant to a processing of the one or more sensed information units; wherein the ensemble is relevant to a first plurality of scenarios; wherein the one or more relevant narrow AI agents are configured to process the one or more sensed information units, to provide one or more narrow AI agent outputs; an intermediate result unit that is configured to process the one or more narrow AI agent outputs to provide an intermediate result; and a response unit that is configured to generate a response based on the intermediate result; wherein each narrow AI agent is relevant to a respective fraction of the first plurality of scenarios.

There may be provided a computerized system that may include an obtaining unit configured to obtain one or more sensed information units; an ensemble of narrow AI agents; a perception unit that is configured to determine based on the one or more sensed information units, one or more relevant narrow AI agents of the ensemble, that are relevant to a processing of the one or more sensed information units; wherein the ensemble is relevant to a first plurality of scenarios; wherein the one or more relevant narrow AI agents are configured to process the one or more sensed information units, to provide one or more narrow AI agent outputs; an intermediate result unit that is configured to process the one or more narrow AI agent outputs to provide an intermediate result; wherein the intermediate result is indicative of a response to the one or more sensed information units; and wherein each narrow AI agent is relevant to a respective fraction of the first plurality of scenarios.

The computerized system may be configured to execute any step or any combination of steps of method 100.

The non-transitory computer readable medium that stores instructions for executing any step or any combination of steps of method 100.

It is appreciated that software components of the embodiments of the disclosure may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the disclosure. It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub combination. It will be appreciated by persons skilled in the art that the embodiments of the disclosure are not limited by what has been particularly shown and described hereinabove. Rather the scope of the embodiments of the disclosure is defined by the appended claims and equivalents thereof.

1. A method for operating an ensemble of narrow AI agents, the method comprises:
obtaining one or more sensed information units;
determining, by a perception unit and based on the one or more sensed information units, one or more relevant narrow AI agents of the ensemble, that are relevant to a processing of the one or more sensed information units; wherein the ensemble is relevant to a first plurality of scenarios;
processing the one or more sensed information units, by the one or more relevant narrow AI agents, to provide one or more narrow AI agent outputs; and processing, by an intermediate result unit, the one or more narrow AI agent outputs to provide an intermediate result; and
generating a response, by a response unit, based on the intermediate result; wherein each narrow AI agent is relevant to a respective fraction of the first plurality of scenarios.

2. The method according to claim 1 for at least some of the narrow AI agents the respective fraction is smaller than one percent of the first plurality of scenarios.

3. The method according to claim 1 wherein a number of narrow AI agents relevant to one of the first plurality of scenarios differs from a number of narrow AI agents relevant to another of the first plurality of scenarios.

4. The method according to claim 1 wherein a number of narrow AI agents exceeds one thousand.

5. The method according to claim 1 wherein a number of narrow AI agents exceeds one hundred thousand.

6. The method according to claim 1 wherein each narrow AI agent is trained to respond to a respective traction of the first plurality of scenarios.

7. The method according to claim 1 wherein at least some of the narrow AI agents comprise at least a portion of a neural network.

8. The method according to claim 1 wherein the determining of the one or more relevant narrow AI agents comprises determining one or more obtained scenarios that are related to the one or more sensed information units, and determining a relevancy of the narrow AI agents based on a relationship between the one or more obtained scenarios and an association between the first plurality of scenarios and the narrow AI agents.

9. The method according to claim 8 wherein the determining of the one or more relevant narrow AI agents comprises determining that a narrow AI agent is relevant when the narrow AI agent is associated to any of the one or more obtained scenarios.

10. The method according to claim 8 wherein the association between the first plurality of scenarios and the narrow AI agents is manually determined.

11. The method according to claim 8 wherein the association between the first plurality of scenarios and the narrow AI agents is determined based on previous determining made by the perception router.

12. The method according to claim 1 wherein the determining of the one or more relevant narrow AI agents comprises determining one or more obtained scenario parts that are related to the one or more sensed information units, and determining a relevancy of the narrow AI agents based on a relationship between the one or more obtained scenario parts and an association between the first plurality of scenarios and the narrow AI agents.

13. The method according to claim 12 wherein at least some of the obtained scenario parts are associated with one or more objects that were sensed in the one or more sensed information units.

14. The method according to claim 1 comprising feeding the one or more sensed information units to each one of the one or more relevant narrow AI agents.

15. The method according to claim 1 comprising determining which part of the one or more sensed information units to send to each relevant narrow AI agent.

16. The method according to claim 1 wherein a narrow AI agent output is a command.

17-18. (canceled).

19. The method according to claim 1 wherein a narrow AI agent output is a suggested response of the response unit.

20. The method according to claim 1 intermediate result unit is configured to select at least one selected narrow AI agent output of the one or more narrow AI agent outputs.

21. The method according to claim 1 intermediate result unit is configured to average the one or more narrow AI agent outputs.

22. The method according to claim 1 wherein each narrow AI agent output of the one or more narrow AI agent outputs is associated with a time period.

23. The method according to claim 1 wherein different narrow AI agent outputs of the one or more narrow AI agent outputs are associated with different time periods, wherein the intermediate result unit is configured to generate an intermediate result that is responsive, at each of the different time periods, to a narrow AI agent output related to the time period.

24. (canceled)

25. The method according to claim 22 wherein the intermediate result comprises instructions for operating a robot.

26. The method according to claim 1 wherein the processing by the intermediate result unit comprises combining multiple narrow AI agent outputs by applying risk reduction optimization.

27. The method according to claim 1 wherein the determining of the one or more relevant narrow AI agents of the ensemble is based on the one or more sensed information units and based on at least one additional parameter.

28. The method according to claim 27 wherein the at least one additional parameter is a purpose assigned to the method.

29. (canceled)

30. A non-transitory computer readable medium that stores instructions for operating an ensemble of narrow AI agents, the operating comprises:
obtaining one or more sensed information units;
determining, by a perception unit and based on the one or more sensed information units, one or more relevant narrow AI agents of the ensemble, that are relevant to a processing of the one or more sensed information units; wherein the ensemble is relevant to a first plurality of scenarios;
processing the one or more sensed information units, by the one or more relevant narrow AI agents, to provide one or more narrow AI agent outputs; and processing, by a intermediate result unit, the one or more narrow AI agent outputs to provide an intermediate result; and
generating a response, by a response unit, based on the intermediate result; wherein each narrow AI agent is relevant to a respective fraction of the first plurality of scenarios.

31. (canceled)

32. A computerized system that comprises:
an obtaining unit configured to obtain one or more sensed information units; an ensemble of narrow AI agents;
a perception unit that is configured to determine based on the one or more sensed information units, one or more relevant narrow AI agents of the ensemble, that are relevant to a processing of the one or more sensed information units; wherein the ensemble is relevant to a first plurality of scenarios;
wherein the one or more relevant narrow AI agents are configured to process the one or more sensed information units, to provide one or more narrow AI agent outputs;
an intermediate result unit that is configured to process the one or more narrow AI agent outputs to provide an intermediate result; and
a response unit that is configured to generate a response based on the intermediate result;
wherein each narrow AI agent is relevant to a respective fraction of the first plurality of scenarios.

33. (canceled)
